(19) United States
(12) Patent Application Publication
(10) Pub. No.: US 2006/0260451 A1
(43) Pub. Date: Nov. 23, 2006

(54) Robotically driven ultrasonic tools

(76) Inventor: Roberto Capodieci, Glen Ellyn, IL (US)

Correspondence Address: Pauley Petersen & Erickson, Suite 365, 2800 West Higgins Road, Hoffman Estates, IL, 60195, US

(21) Appl. No.: 11/404,057

(22) Filed: Apr. 13, 2006

Related U.S. Application Data
(60) Provisional application No. 60/670,776, filed on Apr. 13, 2005.

(51) Int. Cl. B26D 1/00

(52) U.S. Cl. 83/34; 83/932

(57) ABSTRACT

A method for portioning a food product at a single location with a single cutting system includes transporting a food product to a cutting station, activating a multi-axis robotic arm to position at least one ultrasonic cutting blade in proximity to the food product, cutting the food product along a first axis, activating the robotic arm to reposition the at least one ultrasonic cutting blade, and cutting the food product along a second axis. The robotic arm may be programmed to perform a variety of cutting motions and/or cutting patterns. Additionally, the method may include the step of cutting the food product along a third axis.

This application claims the benefit of U.S. Provisional Application 60/670,776 filed on 13 Apr. 2005.

### FIELD OF THE INVENTION

This application relates generally to a method and apparatus for ultrasonically cutting products with robotics. The invention may be used in connection with food products such as, for example, baklava, Turkish Delights, portioning of cakes and/or pies, and non-food products such as, for example, cutting of rubber or deburring of molded plastic parts.

### BACKGROUND OF THE INVENTION

Over the last decade many applications have been developed and implemented to cut and portion a large number of food and non-food products utilizing ultrasonic technology. In this respect, a great emphasis was typically placed on the choice of ultrasonic frequency along with blade size and profile to best suit the characteristics of the product. The selection of the type of drive to actuate the ultrasonic stack in order to accomplish the desired motion profile and cutting rates was relegated to a less prominent role.

Typical retrofits of existing equipment involved traditional reciprocating mechanical systems with complex and often unreliable and inflexible components like cams, eccentrics, linkages and pneumatics. The result was that the cutting action could not be properly optimized and, equally inadequately, product size changes could be accommodated only through lengthy, time-consuming change over procedures.

A large number of products still could not be subjected in a practical and efficient way to any of the traditional or more refined reciprocating drive systems. For example, many products in the baking industry are prepared in trays and cut at different stages of the cooking process, for example, before the baking process, immediately after the baking process and/or after a suitable conditioning period following the baking process.

For example, products like baklava must be cut in the trays in which the product has been layered and assembled before baking. Traditionally, this operation is done manually which requires the utilization of skilled operators which may result in long portioning times per tray of product. Additionally, the resulting portions may be of inaccurate dimensions with respect to desired product standards. Equally detrimental is the pinching of the thin layers of phyllo dough along the cutting lines which prevents the dispersion of liquid butter before baking and that of honey after baking throughout the layers. Also, because the manual cutting action requires a hard surface to contrast the edge of the cutting blade, only rigid aluminum trays can be used instead of soft aluminum pans that may be more desirable from the standpoint of distribution and sale of the products. Finally, manual cutting operation is generally conducive only to simple straight-line cutting patterns with complex patterns being too time-consuming and/or irreproducible.

An attempt to automate such a cutting process entails the use of multiple parallel reciprocating blades. These arrays of blades are used to execute the cutting process somewhat faster, but do not address or solve any of the quality issues previously discussed.

Products like borek, lasagna, Napoleons or tiramisu cakes, all of which are layered products assembled in pans or trays, are portioned manually after baking or chilling at considerable cost in an industrial setting. Other products like pies, focaccia, brownies, cakes and breads are also portioned after baking. However, these products, in most cases, in order to be subjected to a somewhat automatic portioning system, need to be removed from their baking pans and be held in place at the cutting station for the duration of the cutting process.

Non-baked food products which are difficult to cut include, for example, Turkish Delights. Turkish Delights is a jelly product made from a warm liquid base poured into a lined wooden tray containing a thick layer of compacted starch on the bottom. The filled trays are stacked in carts and kept overnight to allow the product to cool and cure. In order to cut the cooled candy into the traditional small cubes and bars, the slab of jelled liquid must be first removed from the tray, heavily dusted with starch and subsequently cut into solid strips through a series of transverse cuts. Each strip is separated from the parent slab and then individually sprayed with starch to prevent the strips from sticking together when re-compacted into a portioned slab.

After the portioned slab is re-compacted, the slab is turned manually by 90 degrees and re-fed on the cutting system to execute the second cross cut. Each portioned row must again be separated manually from the parent slab and starch coated so that the finished products do not stick together.

Such multi-step manual process of separating, spraying and re-compacting or collating the products after every cut may result in: (1) snaking and/or twisting of the strips such that product dimensions and/or shape are inconsistent; (2) piece weight variations; and (3) inefficient and ineffective presentation of the products to the packing station.

In another method for portioning Turkish Delights, the cutting is done by cutting tools having a plurality of parallel longitudinal cutting blades connected in the back by transverse cutting elements. In such an arrangement, multiple individual products are made in one plunging movement. However, due to their intrinsic nature, the products must be dusted in a rotary tumbler to prevent them from sticking and agglomerating together. This approach too results in misshapen products and may require complex manual or automatic systems to ensure the proper product presentation to packaging.

In both cases, given the flexible and pliable nature of Turkish Delights, while the slab inside the tray assumes the precise rectangular perimeter of the tray, once the slab is removed from the tray its contour becomes irregular. Therefore, the process typically requires a preliminary trimming of the sides of the portioned slab resulting in the generation of undesirable scrap.

In view of the above, a need or desire exists for a drive system capable of delivering effective, reliable and flexible cutting operations.

Additionally, there is a need or desire to depart from conventional cutting patterns and resulting product shapes.

There is a further need or desire for a method and/or apparatus that quickly and reproducibly portions food products.

### SUMMARY OF THE INVENTION

In response to the discussed difficulties and problems encountered in the prior art, a method for portioning a food product at a single location with a single cutting system has been developed.

The method according to the invention includes transporting a food product to a cutting station, activating a multi-axis robotic arm to position at least one ultrasonic cutting blade in proximity to the food product, cutting the food product along a first axis, activating the robotic arm to reposition the at least one ultrasonic cutting blade, and cutting the food product along a second axis. The robotic arm may be programmed to perform a variety of cutting motions and/or cutting patterns. Additionally, the method may include the step of cutting the food product along a third axis. The food product may be portioned simultaneously by or through a series of equidistant, congruent cuts along the first axis, along the second axis or along the first and second axes. Alternatively, the food product may be portioned by a series of parallel cuts made in opposite directions. The method according to the invention may also include transporting a food product to a second cutting station and activating the robotic arm to alternate between the two cutting stations such that each food product is portioned at a single location with the same ultrasonic blade(s).

An ultrasonic cutting system suitable for carrying out the method of the invention includes a first cutting platform, a multi-axis robotic arm, and an ultrasonic stack flexibly connected to an end tip of the robotic arm. The ultrasonic stack includes at least one ultrasonic cutting blade. The cutting system also includes control system which runs a cutting routine to portion the food in a select pattern. The cutting routine may include a series of cutting steps, each cutting step followed by a transition step which may activate the robotic arm to reposition the ultrasonic stack. In one embodiment, the cutting routine may include the steps of activating the robotic arm to position the ultrasonic stack, initiating a cutting motion, cutting the product, activating the robotic arm to disengage the ultrasonic cutting blade(s) from the product, and activating the robotic arm to reposition the ultrasonic stack. The cutting system may also include a second cutting platform and the cutting routine may activate the robotic arm to alternate between the two cutting platforms. The cutting system may further include a transport system to convey food products to the cutting system on a continuous or intermittent basis.

Other objects and advantages of the invention will be apparent to those skilled in the art from the following detailed description taken in conjunction with the appended claims and drawings.

### BRIEF DESCRIPTION OF THE DRAWINGS

FIG. 1 is a schematic of a cutting system according to one embodiment of the invention.

FIG. 2 depicts a robotic arm suitable for use in the cutting system.

FIGS. 3A-3E depict full wave, ultrasonic cutting blades suitable for use in the cutting system.

FIGS. 4A-4C depict dagger ultrasonic cutting blades suitable for use in the cutting system.

FIGS. 5A-5D depict half wave, ultrasonic cutting blades suitable for use in the cutting system.

FIG. 6 depicts 20 KHz, full wave, composite cutting blade with four cutting elements suitable for use in the cutting system.

FIGS. 7-14 illustrate cutting patterns in accordance with the invention.

FIGS. 15A-15E depict suitable positioning of one or more cutting blades of the cutting system with respect to a food product in accordance with one embodiment of the invention.

FIGS. 16A-16D depict a method for portioning food product along a first according to one embodiment of the invention.

FIGS. 17A and 17B illustrate a method for portioning Turkish Delights in accordance with one embodiment of the invention.

FIGS. 18A-18C illustrate a method for portioning Turkish Delights in accordance with another embodiment of the invention.

FIG. 19 depicts an ultrasonic cutting system for cutting a non-food product in accordance with a further embodiment of the invention.

### DETAILED DESCRIPTION OF THE INVENTION

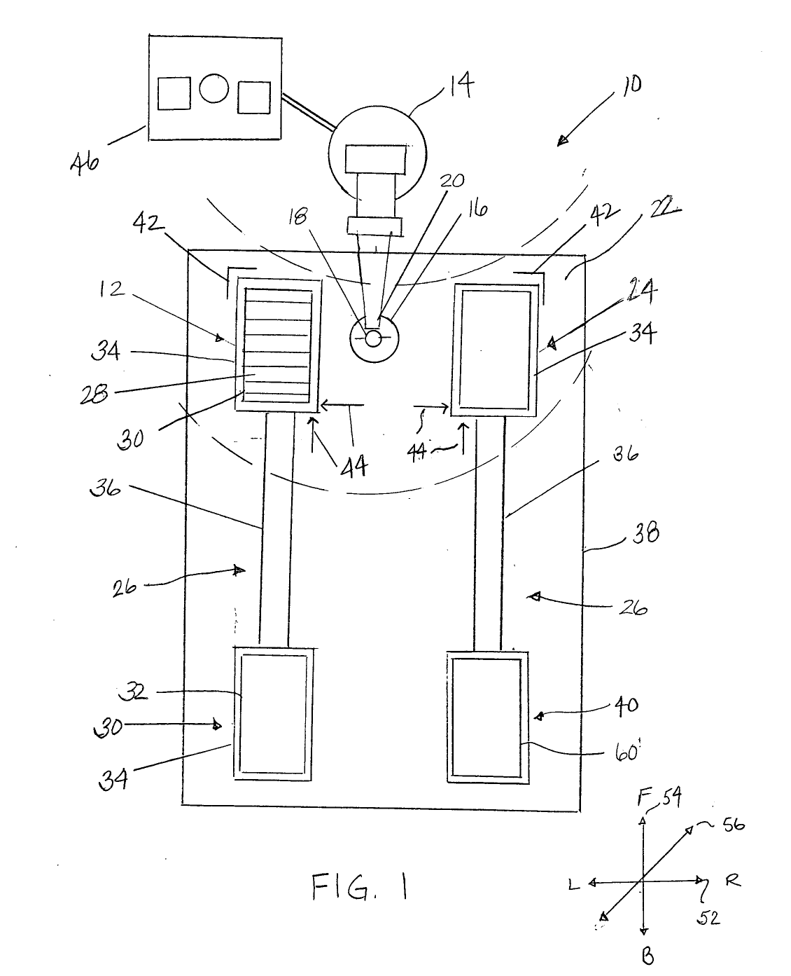

Given the inadequacies and complexities of the cutting process discussed above, a cutting system to efficiently and reproducibly portion a food product, such as a bakery item, at a single location with a single, automated cutting system has been developed. Referring to FIG. 1, the cutting system 10 includes a first cutting platform 12, a multi-axis robotic arm 14 and an ultrasonic stack or hand 16 connected to an end tip or wrist 20 of the robotic arm 14. The ultrasonic stack 16 includes at least one ultrasonic cutting blade 18.

Suitably, the ultrasonic stack 16 is connected to the robotic arm 14 via an elastomeric mounting of suitable durometer or elasticity. In this way, the resulting flexible connection is sufficient to compensate for small deformities in the food product being portioned and/or a pan or tray containing the food product.

Advantageously, the robotic arm 14 may be equipped with sensors (not shown) to reduce and/or prevent direct, hard force contact of the ultrasonic cutting blade(s) 18 with the side walls or bottoms of trays or pans containing the food product, particularly those made of hard metals, or the surface of the cutting platform 12 when a food product is placed directly on the platform.

In cases where the food product is contained in hard metal pans or trays the robotic arm 14 may be equipped with one or more optical sensors (not shown). Suitably, if the product allows, the optical sensors may be used to identify and/or maintain a gap or clearance of about 1 millimeter between the ultrasonic cutting blade(s) 18 and the inner walls of the tray or pan. This is especially possible for products having a crusty outer shell such as, for example, pies since the blade(s) 18 can execute a quality cut of the pie crust while maintaining relatively small gaps.

Frequently, hard metal trays or pans, during handling operations, can be damaged or distorted such that the side walls may be bent inward or bumps or dents may be formed on the bottom or side walls. However, such distortions may be incompatible with pre-established clearance tolerances. To accommodate distortions of the trays or pans, the robotic arm 14 may be equipped with one or more pressure sensors (not shown) that sense additional resistance from the damage point of the pan or tray and allow the ultrasonic stack 16 and the attached ultrasonic cutting blade(s) 18 to float or spatially adjust so that any incidental contact becomes glancing as opposed to hard.

When products to be portioned are contained in or laid on trays of softer material such as plastic, Teflon or soft aluminum, any direct contact between the ultrasonic cutting blade(s) 18 and the tray, provided that it is momentary and at low force, usually does not have a damaging effect on the cutting blade(s). Aluminum foil trays and pans, which may be preferred in the certain segments of the food processing industry, may be used in conjunction with ultrasonic cutting and may be generally more forgiving or tolerant of incidental contact with the ultrasonic cutting blade(s) 18. However, while soft or low force contact between the pan or tray and the ultrasonic blade(s) 18 may result in a simple indentation on the inner walls of the pan, hard contact could cause the ultrasonic blade(s) to penetrate the foil and product a slit. Such damage may be acceptable in cases where products are cut after the baking process and/or do not require the addition of liquids after portioning. However, for certain products, such as baklava which is cut and soaked with butter prior to baking and impregnated with honey after baking, a perforation of the foil tray would be unacceptable.

Referring again to FIG. 1, the robotic arm 14 is positioned so as to cover a working envelope 22 which encompasses the first cutting platform 12. Suitably, the cutting system 10 may include a second cutting platform 24 positioned within the working envelope 22 such that the robotic arm 14 may be alternately positioned over the first cutting platform 12 and the second cutting platform 24.

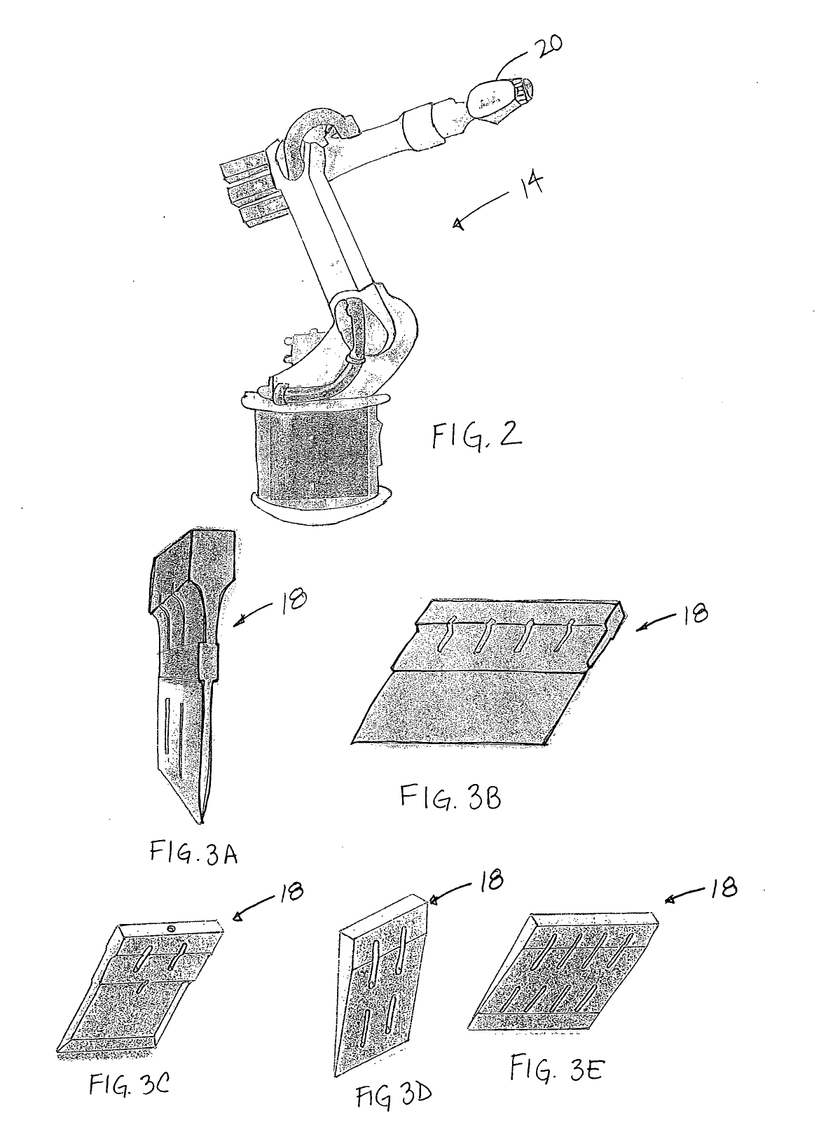

Referring to FIG. 2, a suitable multi-axis robotic arm 14 may be a six axis articulated arm having a nominal payload up to about 16 Kg. One multi-axis robotic arm 14 suitable for use in the present invention is a model KR16 robotic arm available from KUKA Roboter GmbH, through KUKA Robotics Corp. located in Clinton Township, Michigan. Alternatively, the robotic arm 14 may function in fewer than six axes depending upon the complexity of the cutting pattern and/or other product positioning equipment which may be included in the cutting system.

For a desired product, presentation, orientation and/or direction of product flow to a cutting platform, the robotic arm 14 may be programmed or activated to follow a desired portioning template or cutting pattern. Suitably, the robotic arm 14 is activated to move the ultrasonic stack 16 and the attached ultrasonic cutting blade(s) 18 along multiple planes or axes, directions or cutting patterns to produce portioned food products having a select or desired shape, size or appearance.

The ultrasonic stack 16 may include one or more ultrasonic cutting blade(s) 18 having a variety of different characteristics, shapes, operating frequencies and amplitudes. Suitably, the ultrasonic cutting blade(s) 18 may be operated at a frequency of about 15 to about 45 KHz. The ultrasonic cutting blade(s) 18 may be operated at an amplitude of about 0 to about 120 microns. It should be understood that the nature of the product to be portioned will likely dictate the choice of blade design, operating frequency and amplitude for a given application.

In one embodiment, the ultrasonic cutting blade(s) 18 may be a full wave blade such as a 30 KHz full wave, composite blade as shown in FIG. 3A, a 20 KHz full wave blade as shown in FIG. 3B, a 20 KHz full wave blade with sharp edges as shown in FIG. 3C, a 20 KHz full wave, asymmetric slim blade as shown in FIG. 3D or a 20 KHz full wave, asymmetric robust blade as shown in FIG. 3E.

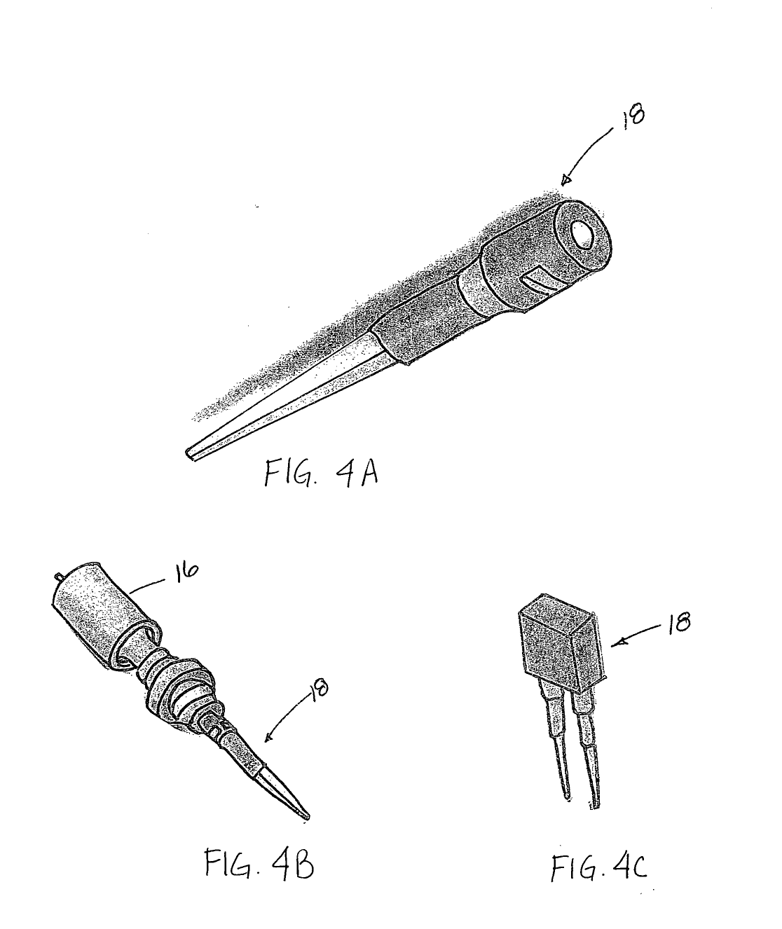

In another embodiment, the ultrasonic cutting blade(s) 18 may be a dagger blade such as a 30 KHz dagger/stiletto, full blade as shown in FIG. 4A, a 30 KHz ultrasonic stack 16 with a dagger blade as shown in FIG. 4B or a 40 KHz composite, double dagger horn as shown in FIG. 4C.

To those skilled in the art, it will be obvious that the edge(s) of a fully resonant dagger blade may not operate at uniformly constant amplitude. The amplitude maximum occurs at the tip of the blade and its value progressively decreases toward the nodal point. Therefore, different layers of a product being portioned may be subjected to different amplitude values and cutting action. Typically, the optimally active area for this kind of blade extends to about 20 mm from the tip of the blade. Inclining the dagger blade may further reduce the active area on the vertical projection. Thus, higher or thicker products may require a different kind of blade and/or operating frequency to achieve uniform and/or reproducible cuts.

In a further embodiment, the ultrasonic cutting blade(s) 18 may be a half wave blade such as a standard 20 KHz half wave blade as shown in FIG. 5A, a 40 KHz half wave blade having an octagonal upper portion as shown in FIG. 5B, a 40 KHz half wave having a rectangular upper portion as shown in FIG. 5C or a 30 KHz, half wave, high gain, special profile blade as shown in FIG. 5D.

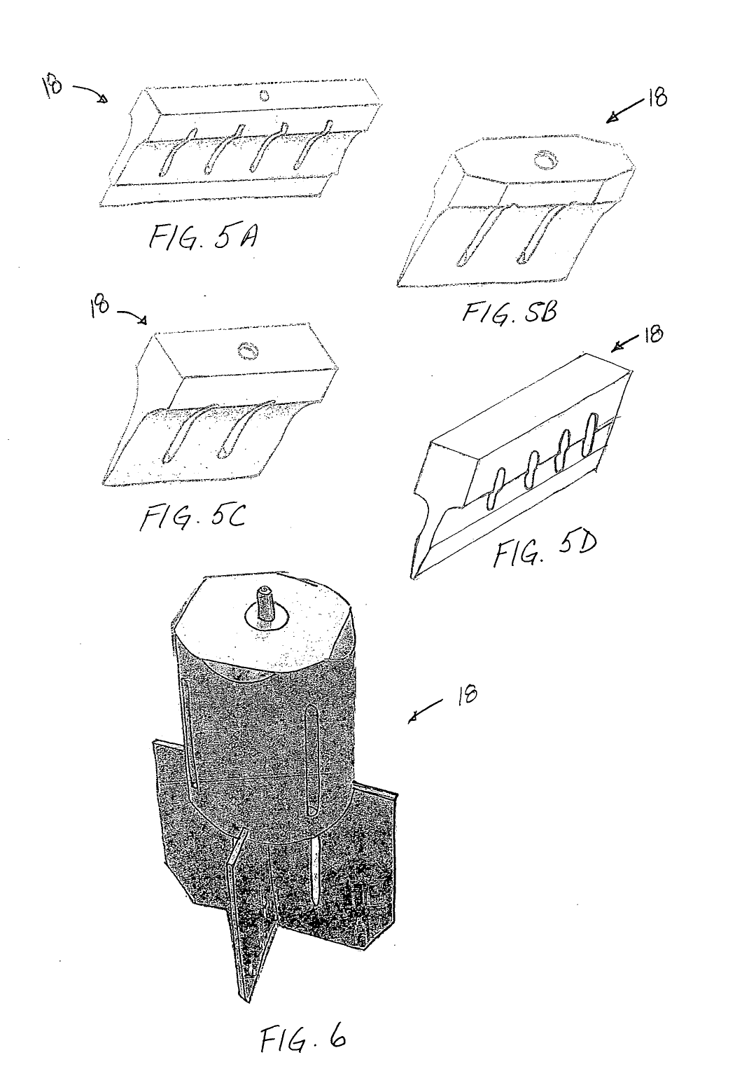

In an additional embodiment, the ultrasonic cutting blade(s) 18 may be a multi-cutting element blade such as a 20 kHz, full composite horn with four elements arranged in a cross pattern as shown in FIG. 6. This type of ultrasonic cutting blade may be suitable for portioning pies, for example.

Referring again to FIG. 1, the cutting system 10 may include a transport system 26 to convey food products 28 from a first staging station 30 to the first cutting platform 12. Suitably, the food products 28 may be contained in a tray 32 which may be, optionally, placed on a tray carrier 34. The use of a tray carrier 34 may be particularly suited to cutting processes where the food product to be portioned is contained in or laid on a soft aluminum or foil tray.

The tray carrier 34 may be moved along a tray carrier track 36 by, for example, pneumatic actuators (not shown) situated under a work table 38 which supports the first staging station 30, the first cutting station 12 and, optionally, the second cutting platform 24 and a second staging station 40. Suitably, the tray carrier(s) 34 may be held in place on the first cutting platform 12 and/or second cutting platform 24 by zero reference corners 42 and pneumatically actuated pistons 44 for the duration of a cutting routine.

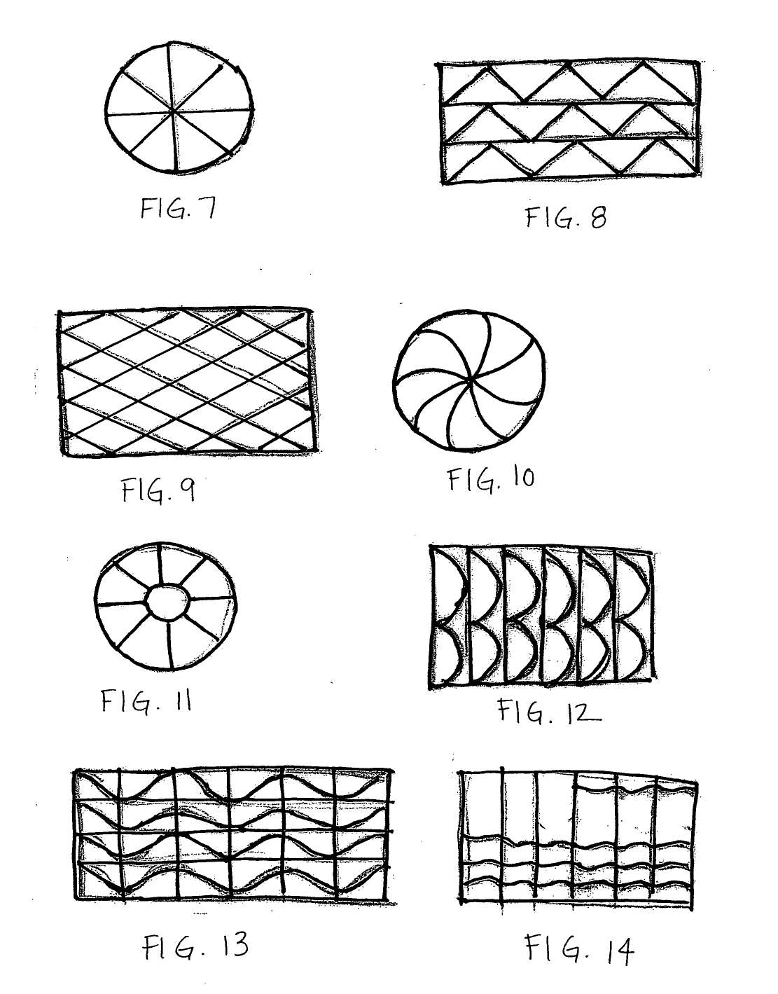

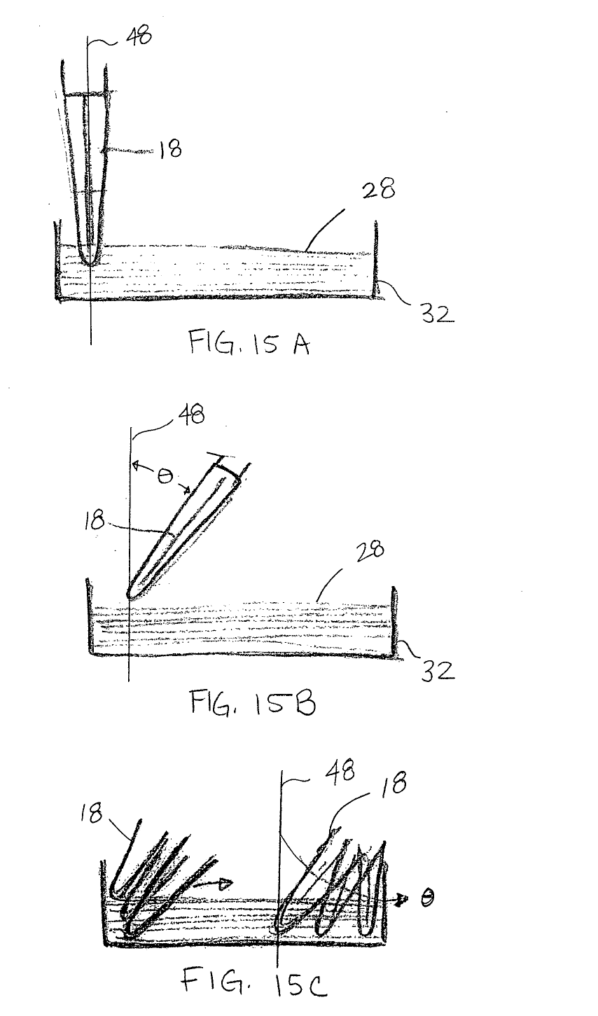

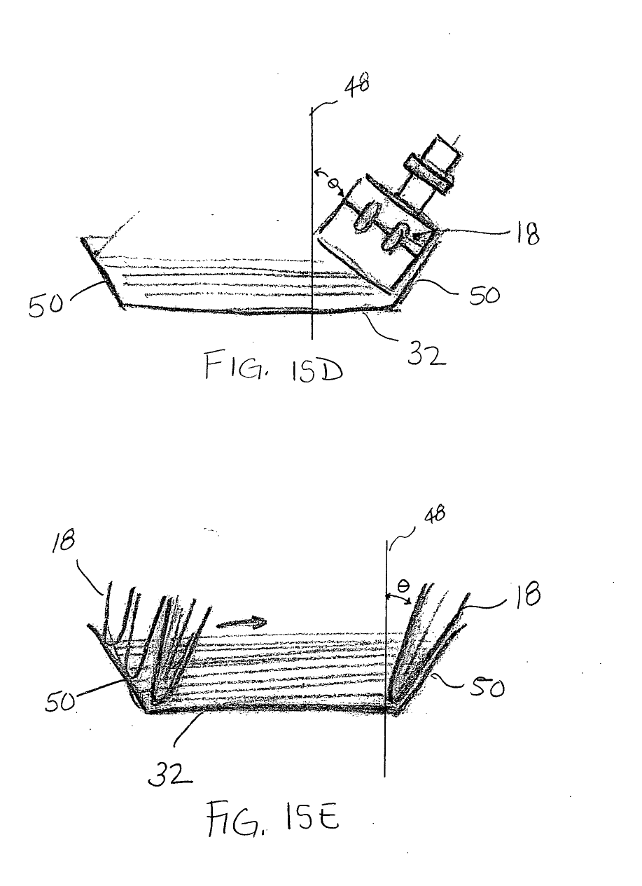

The cutting system 10 may further include a control system 46 which runs a cutting routine to portion the food product in a select pattern. Suitably, the control system 46 may be programmed to activate and direct the robotic arm 14 to perform a cutting motion selected from plunging, slitting and combinations thereof. Alternatively or additionally the control system 46 may be programmed to activate or direct the robotic arm 14 to follow a cutting pattern selected from rectilinear patterns such as, for example, shown in FIGS. 7-9, curvilinear patterns such as, for example, shown in FIG. 10, and combinations thereof such as, for example, shown in FIGS. 11-14.

The cutting system 10 may also include a vision system (not shown) which may include one or more optical sensors and/or one or more pressure sensors to assist in positioning the robotic arm 14 and the attached ultrasonic cutting blade(s) 18 in proximity to the food product to be portioned. Suitably, the vision system, the optical sensors and/or the pressure sensors may be in communication with or integrated into the control system 46 such that the vision systems and/or sensors communicate data to the control system that may be used to adjust cutting parameters defined in the cutting routine.

A cutting routine according to one embodiment includes a series of cutting steps performed according to a predetermine pattern where each cutting step is connect to the next cutting step by a transition step. Such transitions may be used to reposition the ultrasonic cutting blade(s) 18 in proximity to the side walls of the tray 32, allow the blade to clear the side walls of the tray, disengage the blade(s) from the product, index and reposition the blade(s) for the next cut according to increments established by the product dimensions. In particular, a cutting routine may include the steps of activating the robotic arm 14 to position the ultrasonic stack 16, initiating a cutting motion, cutting the product 28, activating the robotic arm 14 to disengage the ultrasonic cutting blade(s) 18 from the product 28 and activating the robotic arm 14 to reposition the ultrasonic stack 16. For maximum flexibility and/or efficiency, the cutting routine may be performed as the product 28 is held stationary at a cutting station 12, or conversely, as the product is moved by a transport system 26, continuously or intermittently, from one predetermined position to another.

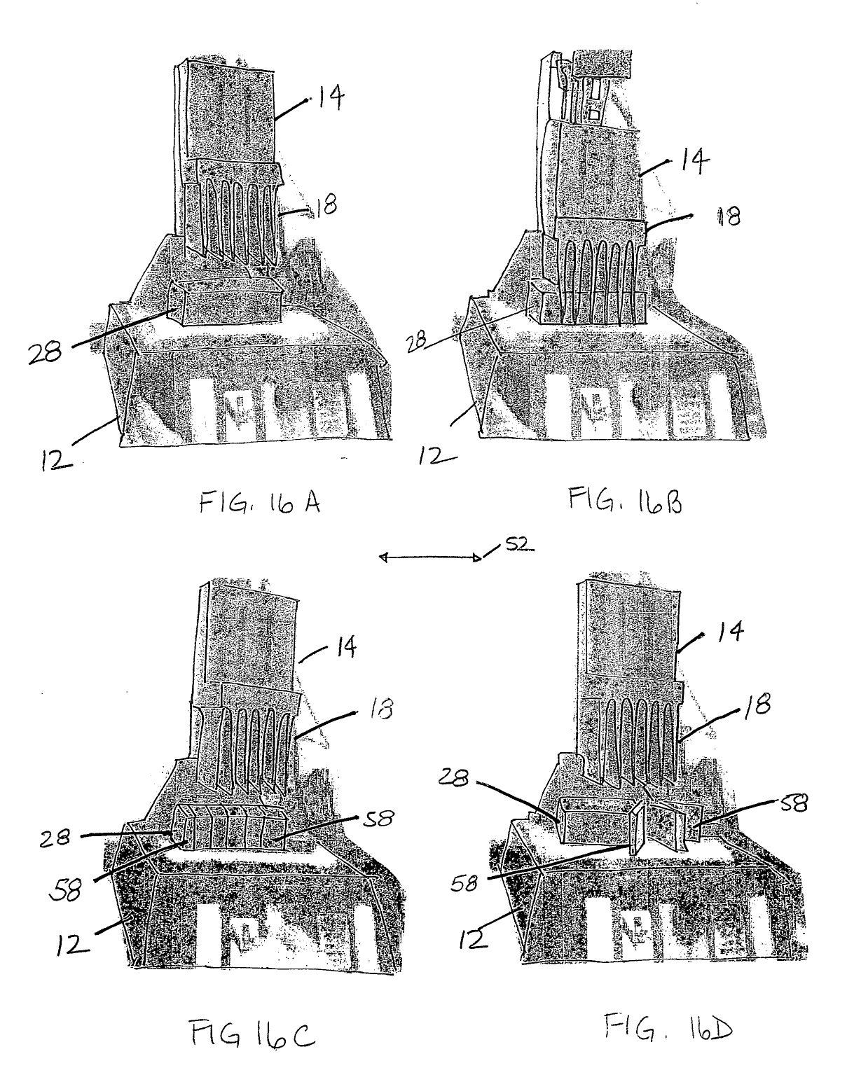

The cutting routine or control system 46 may activate the robotic arm 14 to position the ultrasonic cutting blade(s) 18 at an angle of about −30 to about 30 from vertical. For example, as shown in FIG. 15A, the ultrasonic cutting blade(s) 18 may be positioned substantially vertically, i.e., at an angle (θ) of about 0 degrees with respect to a vertical axis 48. Alternatively, as shown in FIG. 15B, the ultrasonic cutting blades(s) 18 may be positioned at an angle (θ) of up to about 30 degrees from a vertical axis 48. In a further embodiment, as shown in FIG. 15C, the angle (θ) of the ultrasonic cutting blade(s) 18 may varied or changed for successive cuts. By utilizing an angled blade transition steps in the cutting routine may be facilitated and/or accelerated since the robotic arm 14 could execute fewer rotations of smaller angles than those necessary to clear vertical side walls of trays or pans containing the food product to be portioned.

Angling the ultrasonic cutting blade(s) 18 also accommodates the use of soft aluminum or foil pans. As shown in FIG. 15D, soft aluminum or foil pans and trays 32 typically have side walls 50 which are inclined off vertical. Suitably, successive parallel cuts may be made at a single angle setting, as shown in FIG. 15E, to accommodate and/or match the angle of incline of the side walls 50 of the trays 32. Additionally, angling the ultrasonic cutting blade(s) 18 affords the possibility to utilize smaller standard ultrasonic blades operating at about 40 KHz, such as, for example, illustrated in FIG. 5B. Since each blade will be performing slits or cuts on an angle, the product will be engaged by the blade edge operating at a substantially uniform amplitude. Angling the ultrasonic cutting blade(s) 18 may further improve the quality of cuts made through thicker products and cuts or slits made in layered products such as baklava where pinching of the layers is undesirable.

Referring to FIG. 1, as method for portion a food product at a single location using cutting system 10 includes the steps of transporting a food product 28 to a cutting station or platform 12, activating a multi-axis robotic arm 14 to position at least one ultrasonic cutting blade 18 in proximity to the food product 28, cutting the food product along a first axis 52, activating the multi-axis robotic arm 14 to reposition the at least one ultrasonic cutting blade 18, and cutting the food product 28 along a second axis 54. The method may further include the step of cutting the food product 28 along a third axis 56 such that the food product 28 is portioned in three dimensions.

The method may also include the steps of cutting the food product along a first line in a first direction and cutting the food product along a second line in an opposite direction such that the first and second lines are parallel. The method may further include cutting the food product along a third line in a first direction and cutting the food product along a fourth line in an opposite direction such that the third line is one of perpendicular, diagonal or curvilinear with respect to the first line and the fourth line is parallel to the third line.

In another embodiment, the method may also include the steps of sensing a side wall of a tray containing the food product and positioning the at least one ultrasonic cutting blade to clear the side wall.

Referring again to FIG. 1, the method may additionally include the steps of transporting a food product to a second cutting station of platform 24 adjacent to the first cutting platform 12 and activating the robotic arm 14 to alternate between the adjacent cutting platforms such that each food product is portioned at a single location with the same ultrasonic cutting blade 18.

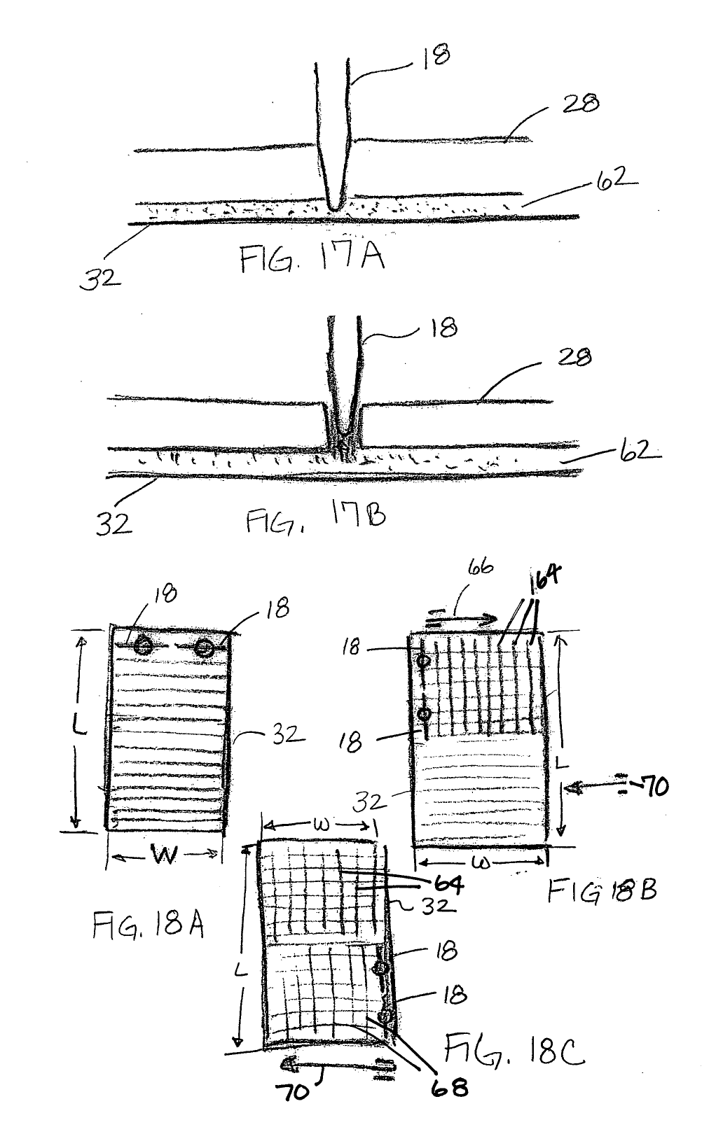

In one embodiment, the food product 28 may be portioned with a series of equidistant, congruent cuts made along the first axis 52, the second axis 54, along the third axis 56 or combinations thereof. Alternatively, the food product 28 may be simultaneously portioned by making multiple equidistant, congruent cuts with a plurality of ultrasonic cutting blades 18 along the first axis 52, along the second axis 54 or along the third axis 56. For example, as shown in FIGS. 16A-16D, a food product 28 may be portioned along a first axis 52 by positioning the food product on a cutting platform 12, activating a robotic arm 14 to position a plurality of ultrasonic cutting blades 18 in proximity to the food product 28, activating to robotic arm 14 to initiate a plunging motion thereby cutting the food product 28 into a plurality of individual slices 58, activating the robotic arm 14 to disengage the ultrasonic cutting blades 18 from the food product 28, and separating the food product 28 into individual slices 58.

In another embodiment (not shown), prior to separating the food product into individual slices, the method may further include the steps of activating the robotic arm to rotate or reposition the ultrasonic cutting blades along a second axis in proximity to the sliced food product, initiating a second cutting motion thereby cutting the sliced food product into a plurality of cubes, disengaging the ultrasonic cutting blades from the food product, and separating the food product into individual cubes. The method may further include, prior to separating the food product into individual cubes, reposition the ultrasonic cutting blades to cut the product along a third axis thereby forming a plurality of smaller cubes.

The present invention is further described in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

### Method and Apparatus for Portioning Baklava

Baklava, a baked food product containing alternating layers of phyllo dough and filing, may be portioned using the method and apparatus described above. Suitably, the cutting system 10 includes the above mention 16 Kg payload robotic arm 14, a 30 KHz ultrasonic stack 16 and an ultrasonic dagger blade 18.

Referring to FIG. 1, the sequence of operations begins with placing trays 32 and 60 containing the baklava at the first staging station 30 and the second staging station 40 and then transporting the trays 32, to the first cutting platform 12 and the second cutting platform 24, respectively. Subsequently, the robotic arm 14 begins its routine by executing the first cut in the left (L) to right (R) direction at the first cutting platform 12. Subsequent cuts are made in an alternating right to left and left to right motions until the first tray 32 of baklava is sequentially portioned along the first axis 52. During the routine, transition steps between each cutting step position the dagger blade 18 in a substantially vertical position during the slitting or cutting motion.

After the first tray 32 of baklava is portioned along the first axis 52, the tray 32 is transport back to the first staging station 30 where the baklava is soaked with melted butter. While this takes place, the robotic arm 14 swings the ultrasonic cutting stack to the second cutting platform 24 where the second tray 60 of baklava is sequentially portioned along the first axis 52 by a series of alternating left to right and right to left cutting motions.

After the second tray 60 of baklava is portioned along the first axis 52, the tray 60 is transported back to the second staging station 40 where the baklava is soaked with melted butter. As this takes place the first tray 32 of baklava is transported back to the first cutting platform 12 to be sequentially portioned along the second axis 54. At the same time, the robotic arm 14 swings the ultrasonic stack 16 to the first cutting platform 12 and the robotic arm 14 continues its routine by executing the first cross cut in the front (F) to back (B) direction at the first cutting platform 12. Subsequent cross cuts are made in an alternating back to front and front to back motions until the first tray 32 of baklava is sequentially portioned along the second axis 54. After the first tray 32 of baklava is portioned along the second axis 54 it is transported back to the first staging area 30 where it may be moved to a holding area or oven area for further processing.

As the first tray 32 of baklava is being transported back to the first staging station 30, the second tray 60 of baklava is transported back to the second cutting platform 24 to be sequentially portioned along the second axis 54. At the same time, the robotic arm 14 swings the ultrasonic stack 16 to the second cutting platform 24 and the robotic arm 14 continues its routine by executing the first cross cut in the front (F) to back (B) direction at the first cutting platform 24. Subsequent cross cuts are made in an alternating back to front and front to back motions until the second tray 60 of baklava is sequentially portioned along the second axis 54. After the second tray 60 of baklava is portioned along the second axis 54 it is transported back to the second staging area 60 where it may be moved to a holding area or oven area for further processing.

As an additional feature, since the execution of the cross cuts may tend to displace and lift the thin and light to layers of phyllo dough, the dagger blade may be positioned at an angle of about −30 to about 30 degrees from vertical. This approach, in conjunction with the gluing action from the melted butter, may allow the slit or cut to be performed rapidly and efficiently without excess displacement of the upper layers of the baklava.

With minor variations, the above described method for portioning baklava may be extended to other layered product such as, for example, lasagna, borek as well as other baked good such as, for example, focaccia, brownies, pies and cakes. Such variants, in order to provide desired or select product characteristics, portion patterns and desired throughputs may require the use of: (1) composite multi-blade ultrasonic cutting horns such as illustrated in FIG. 6; (2) plunging versus slitting cutting motions; (3) a vision system to detect the side walls of pans or trays containing the product to be portioned and/or to position the cutting blade(s) in proximity to the food product; and (4) cutting pattern programs that allow cutting of the products as they move along predetermined paths (“on the fly” cutting).

### Method for Portioning Turkish Delights

A cutting system for portioning Turkish Delights may have the same or substantially similar overall geometry as illustrated in FIG. 1. However, both the type of ultrasonic cutting blade and the cutting patterns may be distinctly different. As was previously described, the primary difficulty in cutting Turkish Delights derives from its stickiness. Product stickiness is responsible for many issues ranging from cut products sticking or adhering the cutting blade, material build-up or accretion on the cutting blade, product deformation, edge trimming requirements and poor product presentation after portioning.

Although ultrasonic cutting may obviate many of these difficulties, such processes typically require addition manual steps to separate the product after cutting which may include dusting the portioned pieces with starch to prevent the products from sticking together. All of this may be eliminated if the cutting and dusting operations can be executed simultaneously.

The tip or face of an ultrasonic horn or blade, as it operated freely in air, due to its rapid and repeated expansion and contraction, has a pumping effect on the air in front of it creating a turbulence often called “air velocity.” The air velocity is a function of the amplitude and frequency at which the horn or blade operates or, more directly, of the resonant vibration as the face of the horn. Air velocity is also a function of the shape and surface area of the face of the horn or blade. The effects of such turbulence are visible if a sheet of paper is placed close to the horn's face since the paper will flutter in response to the turbulence.

The ultrasonic cutting blade illustrated in FIG. 5D has an experimentally-derived operating amplitude above 90 microns, which, as a result of the above-mentioned action may be used to spray or disperse powder starch. As illustrated in FIGS. 17A and 17B, in a method for cutting Turkish Delights, the tip of an ultrasonic cutting blade 18 after having cut through the jelly product and comes into proximity with a layer of starch 62 at the bottom of the tray 32, will create a whirlwind of starch which, as the blade retracts during an upstroke, will effectively coat the cut surfaces of the product.

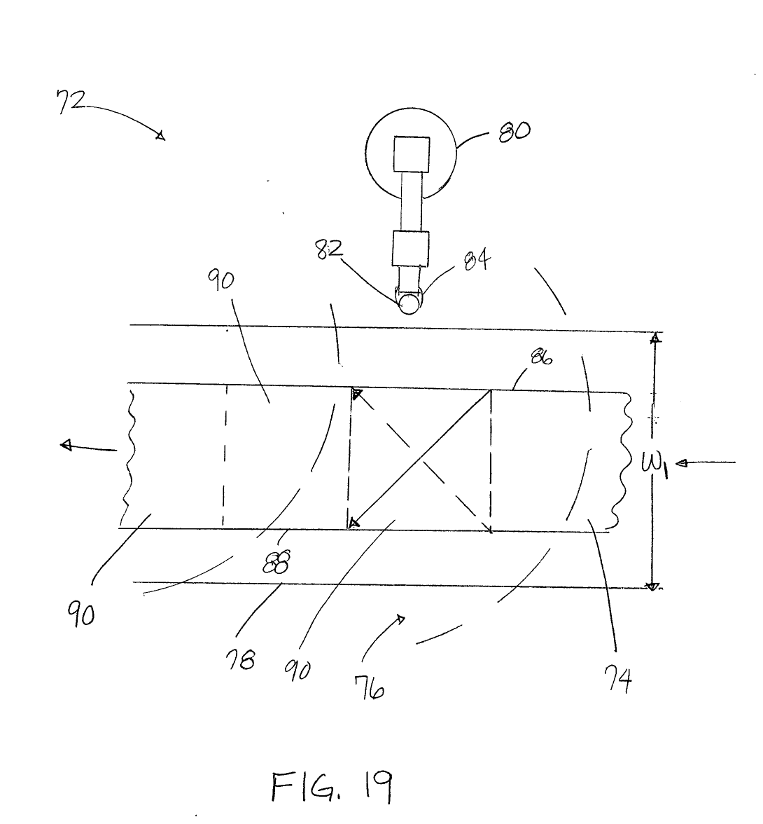

Suitably, as shown in FIGS. 18A-18C, a cutting system suitable for portioning Turkish Delights may include two or more side by side ultrasonic cutting blades 18 of suitable dimension to cover the full width (W) of a tray 32 containing a slab of unportioned Turkish Delights. By maintaining a gap of about 0.2 mm between the blades 18 it will be possible to prevent damaging contact between the blades and ensure continuity of the cut. Due to its intrinsic nature and the narrowness of the gap, the slab of Turkish Delights product will act as if it is being cut by a single solid blade. Suitably, the slab is portioned along the length (L) of the tray 32 by activating a robotic arm to make a series of vertical cuts using a plunging motion as shown in FIG. 18A.

With the use of standardized trays whose length (L) is a multiple of its width (W), the slab of Turkish Delights may be further portioned by a series of vertical cuts made across the width (W) of the tray. For example, as shown in FIGS. 18B and 18C, a tray 32 having a length (L) that is twice the width (W) of the tray may be cross cut using two series of plunging cuts along the width dimension to properly portion the Turkish Delights. Suitably, the first series of cross cuts 64 may be made in a first direction 66 and the second series of cross cuts 68 may be made in an opposite direction 70. Alternatively, the first series 64 and the second series 68 of cross cuts may be made in the same direction.

### Portioning of Non-Food Products

Non-food products like rubber may also be portioned using the above described apparatus. In the tire industry, for example, a continuous slab of rubber moving at a given speed is typically cut into segments having a predetermined length by circular water cooled blades driven by Cartesian XYZ gantries.

As illustrated in FIG. 19, cutting system 72 may be used to portion a continuous slab of rubber 74 as it is transported through a working envelope 76 associated with a multi-axis robotic arm 78. Suitably, the working envelope 76 encompasses the width (W₁) of the conveyor 78 which transports the rubber slab 74. The robotic arm 80 includes an ultrasonic stack 82 equipped with at least one ultrasonic cutting blade. One ultrasonic cutting blade suitable for cutting the rubber slab is illustrated in FIG. 5B.

A wrist 84 of the robotic arm 80 may be moved in a vectorial manner so as to execute cuts or slits from a first side 86 of the rubber slab 74 to a second side 88 of the rubber slab while compensating for the speed at which the slab is moving. In this fashion, the cut segments 90 will have a rectangular perimeter. Advantages of such an approach are the quality of the cut and cleanliness of the cutting station as well as operation flexibility.

The cutting systems disclosed above may also be used for deburring molded plastic parts. Injection molding of plastic objects is often accompanied by the production of undesirable flashing of plastic material. The resulting burr on the object's edge or perimeter is often removed manually with rotary cutters. However, rotary tools often generate fouling, toxic fumes and considerable dust, the latter requiring the use of complex extraction, vacuuming and exhaust systems.

In one embodiment, a robotic arm coupled to a suitably designed ultrasonic cutting blade or horn and cutting routine programmed to follow the contours of a finished product may be used to enhance the deburring process. The benefits from such an approach may include: (1) flexibility of operations by programming the robotic arm to accommodate a wide variety of contours and profiles without the need for dedicated fixtures; (2) cost effectiveness by the elimination of a peripheral systems need to extract fumes and dust; (3) shorter production cycle times; (4) improved product quality through the use of precise and repeatable patterns; and (5) reduction or elimination of health risks due to the removal of fumes, dust and flying particles and/or repetitive manual operations.

In general, the embodiments described above may result in reduced cutting cycle time such as, for example, a reduction to 30 to 45 seconds per tray or product for ultrasonic cutting methods as compared to the typical manual cutting times of 7 to 10 minutes per tray or product. Additionally, the above described methods and apparatus may provide the following benefits: (1) production of innovative shaped products by virtue of new cutting patterns; (2) production of novelty products having complex formulations and filings; (3) precise portion control; and (4) elimination of health risks associated with repetitive wrist motion during manual cutting operations.

While in the foregoing detailed description this invention has been described in relation to certain embodiments, and many details have been set forth for the purposes of illustration, it will be apparent to those skilled in the art that the invention is susceptible to additional embodiments and that certain of the details described herein can be varied considerably without departing for the basic principles of the invention.

I claim:

1. A method for portioning a food product, comprising the steps of:
transporting a food product to a cutting station;
activating a multi-axis robotic arm to position at least one ultrasonic cutting blade in proximity to the food product;
cutting the food product along a first axis;
activating the multi-axis robotic arm to reposition the at least one ultrasonic cutting blade; and
cutting the food product along a second axis,
wherein the food product is portioned at a single location with a single cutting system.

2. The method of claim 1, wherein the multi-axis robotic arm performs a cutting motion selected from the group consisting of plunging, slitting and combinations thereof.

3. The method of claim 1, wherein the multi-axis robotic arm follows a cutting pattern selecting from the group consisting of rectilinear patterns, curvilinear patterns and combinations thereof.

4. The method of claim 1, further comprising the step of:
cutting the food product along a third axis,
wherein the food product is portioned in three dimensions.

5. The method of claim 1, further comprising the step of:
portioning the food product with a series of equidistant, congruent cuts one of along the first axis, along the second axis or along the first and second axes.

6. The method of claim 1, further comprising the step of:
portioning the food product by simultaneously making multiple equidistant, congruent cuts with a plurality of ultrasonic cutting blades one of along the first axis or along the second axis.

7. The method of claim 1, further comprising the steps of:
cutting the food product along a first line in a first direction; and
cutting the food product along a second line in an opposite direction, wherein the first and second lines are parallel.

8. The method of claim 7, further comprising the step of:
cutting the food product along a third line in a first direction;
wherein the third line is one of perpendicular, diagonal or curvilinear with respect to the first line.

9. The method of claim 8, further comprising the step of:
cutting the food product along a fourth line in an opposite direction,
wherein the fourth line is parallel to the third line.

10. The method of claim 1, further comprising the steps of:
sensing a side wall of a tray containing the food product; and
positioning the at least one ultrasonic cutting blade to clear the side wall.

11. The method of claim 1, further comprising the steps of:
transporting a food product to an adjacent cutting station; and
activating the robotic arm to alternate between the adjacent cutting stations,
wherein each food product is portioned at a single location with the same ultrasonic cutting blade.

12. The method of claim 1, further comprising the step of rotating the at least one ultrasonic cutting blade at an angle of about −30 to about 30 degrees from vertical.

13. An ultrasonic cutting system for performing the method of claim 1, comprising:
a control system;
a first cutting platform;
the multi-axis robotic arm; and
an ultrasonic stack including at least one ultrasonic cutting blade, the ultrasonic stack flexibly connected to an end tip of the robotic arm,
wherein the control system runs a cutting routine to portion the food product in a select pattern.

14. The ultrasonic cutting system of claim 13, further comprising a second cutting platform.

15. The ultrasonic cutting system of claim 14, wherein the cutting routine directs the robotic arm to alternate positions between the first cutting platform and the second cutting platform.

16. The ultrasonic cutting system of claim 13, wherein the cutting routine comprises a series of cutting steps, each cutting step followed by a transition step.

17. The ultrasonic cutting system of claim 16, wherein the transition step activates the robotic arm to reposition the ultrasonic stack.

18. The ultrasonic cutting system of claim 13, wherein the cutting routine comprises the steps of:
activating the robotic arm to position the ultrasonic stack;
initiating a cutting motion;
cutting the product;
activating the robotic arm to disengage the at least one ultrasonic cutting blade from the product; and
activating the robotic arm to reposition the ultrasonic stack.

19. The ultrasonic cutting system of claim 13, further comprising a transport system to convey product to the ultrasonic cutting system on a continuous or an intermittent basis.

20. The ultrasonic cutting system of claim 12, wherein the food product is a bakery item.
